(19) United States
(12) Patent Application Publication
(10) Pub. No.: US 2024/0351023 A1
(43) Pub. Date: Oct. 24, 2024

(54) MODULAR MULTI-LAYER MICROFLUIDIC CARTRIDGES

(71) Applicant: Coagulo Medical Technologies, Inc., Auburndale, MA (US)

(72) Inventors: Galit H. Frydman, Boston, MA (US); Alexander H. Slocum, Bow, NH (US); Folkers E. Rojas, Buckeye, AZ (US)

(21) Appl. No.: 18/682,931

(22) PCT Filed: Aug. 9, 2022
(86) PCT No.: PCT/US2022/039842

§ 371 Date: Feb. 11, 2024

Related U.S. Application Data
(60) Provisional application No. 63/232,448, filed on Aug. 12, 2021.

(51) Int. Cl. B01L 3/00

(52) U.S. Cl. CPC B01L 3/502707; B01L 2200/025; B01L 2200/028; B01L 2200/12; B01L 2300/0887

(57) ABSTRACT

The present invention generally relates to multi-layer microfluidic cartridges comprising alignment features that can be used during assembly to provide precise alignment of the cartridge's layers with respect to planar and rotational or angular alignments imposed on a first virtual triangle to align all layers of the microfluidic cartridge such that their centers lie on a second virtual triangle, and with each slot's longitudinal axis aligned with the one of the angle bisectors of the second virtual triangle's included angles, and wherein the angle bisectors meet within the respective virtual triangles. Such cartridges are suitable for use in medical diagnostics, for example.

### FIELD OF THE INVENTION

The present invention relates to modular, multi-layer microfluidic cartridges. More specifically, the present invention relates to modular, multi-layer microfluidic cartridges comprising integrated alignment features, and to methods for the assembly thereof. The cartridges may be used in medical diagnostics for evaluating a bodily fluid sample, including, for example, for evaluating coagulation in a blood sample. The devices and methods described herein can be used for various other applications as well.

### BACKGROUND OF THE INVENTION

Modular medical diagnostic cartridges often comprise a core element containing one or more molded fluidic flow paths and one or more cover layers, wherein the one or more cover layers is attached to the core element to fully enclose the flow path(s) and form one or more channels. In such cartridges, alignment between and among the one or more layers and the core element may be achieved with conventional manufacturing techniques. However, as channel size decreases and complexity increases—for example, where channels must overlap and/or align with particular features integrated into the cartridge (e.g., electronic sensors)—accurate alignment of layers to the core element becomes increasingly critical.

The challenges to manufacturing and assembling modular, multi-layer microfluidic cartridges do not necessarily exist for other multi-layer precision devices, such as, for example, electronic circuit boards (such as printed circuit boards). Printed circuit boards (PCBs) often comprise layers, each layer having a defined functionality, that are bound together in a multi-layer “book” by adhesives that are applied to the layers and that cover the entire surface between the layers.

Traditionally, in order for sheets (or layers) of materials to be adhered together, the sheets often are aligned by providing two orthogonal reference edges against which orthogonal straight sides of the sheets to be adhered are placed. The adhesive is often a sheet-type that is not tacky and that slides freely across a surface if kept cold. When held at a compound angle and vibrated, the sheets align to form a “book” ready to be bound. Pressure and heat can then be applied to cause the adhesive to flow and adhere surfaces together. However, for very thin sheets that are also flexible, and where the adhesive is tacky, a different method is needed because, if the sheet is at all non-flat and has any raised regions, a raised region can touch and prematurely adhere, thereby causing a wrinkle; in a microfluidic cartridge, such a wrinkle could produce a fluid short circuit between the adhered sheets and/or result in misalignment of features.

Once the multi-layer “book” is assembled and cured, connections are made between the sheets to create the overall functionality of the device. These connections between sheets are made by drilling vias that are then plated through without worry of leaving a through hole.

Alignment between components, including sheets of materials, is discussed by way of reference in Slocum, A. “Kinematic couplings: A review of design principles and applications”, Int. J. of Machine Tools and Manufacture (2009), doi: 10.1016/j.ijmachtools.2009.10.006, including references cited therein.

The manufacture and assembly of modular, multi-layer cartridges for use in precision diagnostics cannot rely on such legacy processes. For example, there is a concern of adhesive flowing into the fluid passages (e.g., channels). In addition, connection holes between the layers cannot readily be drilled as a post-layering process.

There therefore exists a need in the art for microfluidic cartridges that are suitable for use in, e.g., precision diagnostics, and for techniques for assembling such cartridges. In particular, there is a need for multi-layer microfluidic cartridges wherein the cartridge's layers are precisely and accurately aligned. The present invention addresses such needs.

### SUMMARY OF THE INVENTION

The devices and methods described herein provide alignment features for modular, multi-layer microfluidic cartridges as well as methods related to the assembly of such cartridges.

Embodiments of the present invention provide a multi-layer cartridge comprising a base structure and one or more layers; the first of the one or more layers is bonded or adhered to the base structure and each subsequent layer is bonded or adhered to the previous layer, wherein the base structure and each of the one or more layers has alignment features comprising three slots that are oriented to allow for alignment between and among the base structure and the one or more layers. In particular, the three slots on the base structure and the three slots on each of the one or more layers have the same size, location, and angular orientation, such that the base structure's slots can accurately align with the slots of the one or more layers (e.g., in the X, Y planes, and with respect to rotation about a normal to the surface) to ensure that each of the one or more layers is adhered in a precise planar fashion and further to provide exact kinematic constraint. An assembly fixture may comprise pins (e.g., three round pins) whose locations align with the locations of the alignment features on the base structure and on each of the one or more layers (e.g., with the centroids of the three slots on the base structure and with the centroids of the three slots on each of the one or more layers), such that the assembly fixture can locate and hold flat each of the one or more layers with respect to the assembly fixture and its pins, and such that the assembly fixture's pins may then engage (couple) with the slots in the base structure to allow each of the one or more layers to be accurately brought into planar contact with the portion of the assembly containing the base structure. For the base structure and each of the one or more layers, the three slots engage with three round pins on the assembly fixture, such that the three slots' centers are located on a virtual triangle where the angle bisectors of the triangle's included angles meet at a point that is in the region of greatest alignment accuracy desired between the layered elements, and the slots' centers are located on the triangle vertices and their longitudinal axes are aligned with the corresponding angle bisectors at the triangle's vertices (see FIG. 7). In embodiments described herein, the base structure is itself a layer, and the other layers (e.g., an adhesive layer, a printed circuit board, etc.) are additional layers, wherein all layers can be precisely located with respect to each other by using three pins emanating from an assembly fixture on which the layers are placed, and wherein, even if the pins emanating from the assembly fixture are not accurately located with respect to each other, the layers will be accurately placed with respect to each other. As used herein, the terms “core element” and “base structure” are used interchangeably, unless made clear otherwise from context. In an exemplary embodiment, cartridge body 600 comprises such a base structure (see, e.g., FIGS. 1A & 3).

In various embodiments, the assembly process described herein may be repeated to adhere or bond multiple layers to the portion of the cartridge assembly containing the base structure. In some of these embodiments, there also may be multiple alignment features to permit alignment of multiple layers around different points on or within the same cartridge.

The present invention relates to these and other important aspects, as described herein.

### BRIEF DESCRIPTION OF THE DRAWINGS

FIG. 1A shows an isometric view of the front side of a cartridge embodiment.

FIG. 1B shows an isometric view of the back side of a cartridge embodiment.

FIG. 2A shows a top view of a base structure of a cartridge, with its microfluidic channels integrally molded.

FIG. 2B shows a schematic of a microfluidic flow system.

FIG. 3 shows an exploded view of a cartridge embodiment.

FIG. 4 shows the main regions of a cartridge embodiment.

FIG. 5 shows a cartridge aligning to two round dowel pins (301a and 301b) in an instrument into which the cartridge is placed.

FIG. 6A depicts kinematic alignment of a cartridge to two round dowel pins.

FIG. 6B shows a close-up view of a round dowel pin on a cartridge's V-shaped region.

FIG. 6C shows a close-up view of a round dowel pin on a cartridge's flat region.

FIG. 7 shows three slots (600z) and depicts the slots' alignment along angle bisectors of a virtual triangle whose vertices are at the slots' centers.

FIG. 8 shows an assembly fixture (which may be a vacuum fixture) with three round pins (961d) for kinematic alignment of a base structure and one or more layers of a multi-layer cartridge.

### DETAILED DESCRIPTION OF THE INVENTION

The features and advantages of the present invention may be more readily understood by those of ordinary skill in the art upon reading the following detailed description. It is to be appreciated that certain features of the invention that are described above and below in the context of separate embodiments may also be combined to form a single embodiment. Conversely, various features of the invention that are described in the context of a single embodiment for reasons of brevity may also be combined so as to form sub-combinations thereof. In addition, the drawings and specific embodiments of the invention described herein are illustrated by way of example, it being expressly understood that the description and drawings are only for the purpose of illustration and that the specific embodiments are not intended to define the limits of the present invention.

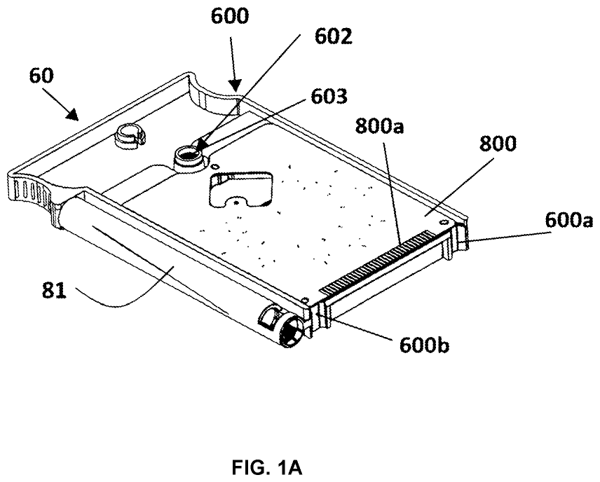

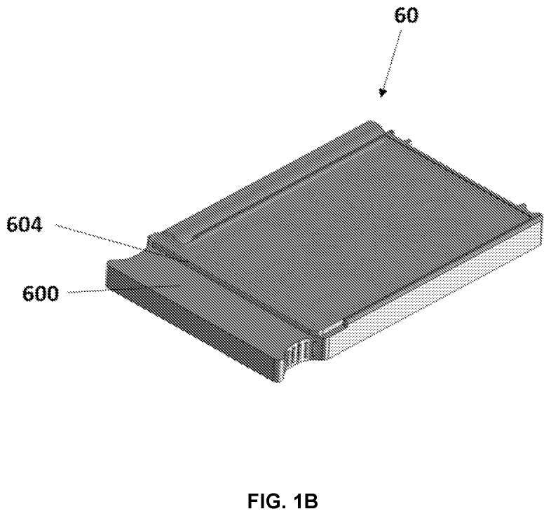

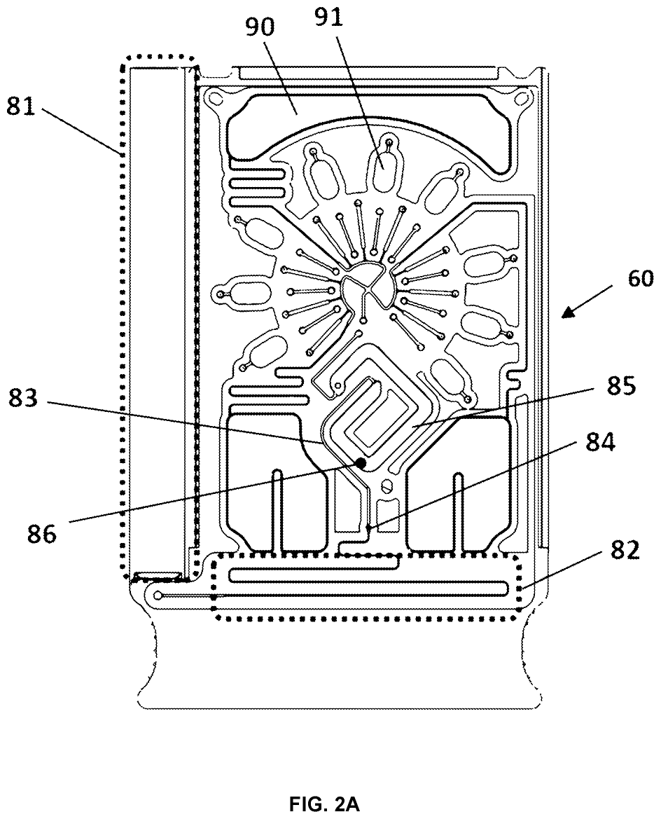

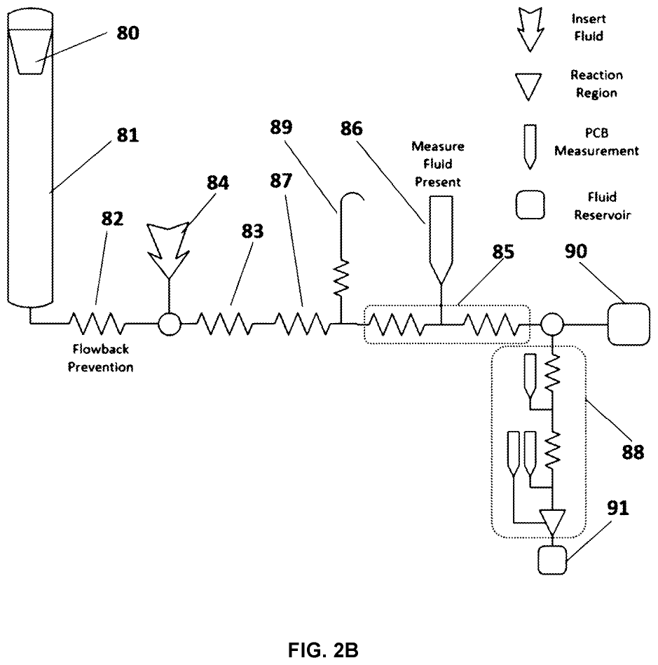

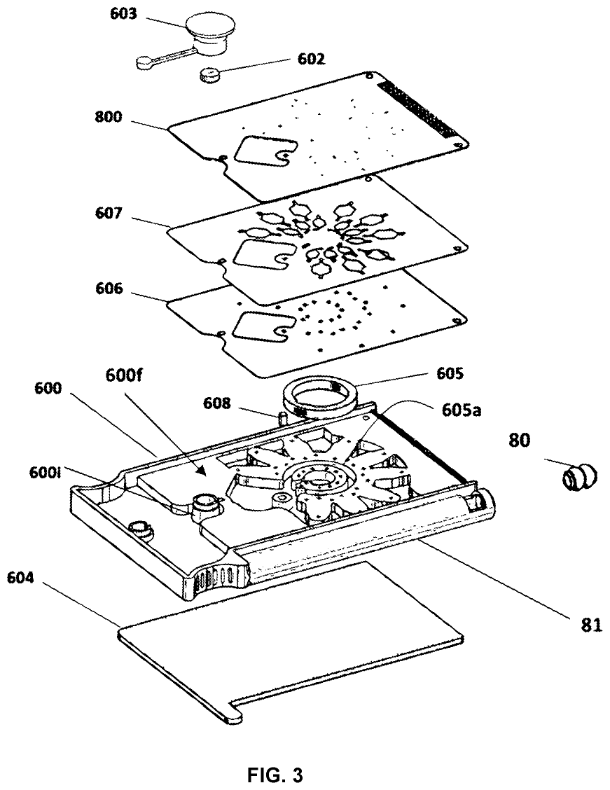

As shown in FIGS. 1A & 1B, cartridge embodiments as described herein are a self-enclosed microfluidic systems that can be used to evaluate fluid samples. For example, cartridge assembly 60 may be used to run an array of blood tests. The cartridge assembly 60 has a cartridge body 600 that comprises the cartridge's base structure, and that contains channels and reservoirs that can be molded into the base structure; during assembly, the open side of the molded fluid flow regions (see, e.g., FIG. 2A), is capped with a cover layer to form closed channels and reservoirs. FIG. 2B shows a schematic of a fluid flow system. One basic function of the cartridge is to accept a fluid sample (e.g., blood) via a sample insertion port 600i, which can be covered by cap 603 to help ensure no sample is exterior of the cartridge (see, e.g., FIG. 3). In some embodiments, the sample insertion port 600i comprises an entry region septum 602, which may be pierced by, e.g., a syringe, and which septum self-seals once the sample insertion device (e.g., syringe) is withdrawn from the sample insertion port 600i. Once inserted into the cartridge, the sample then enters the fluid channels via port 84 (see FIG. 2A). In certain embodiments, it may be particularly important that the sample insertion port 600i (or other entry region) prevents outflow and/or backflow of the sample (e.g., via entry region septum 602); for example, containment of the sample within the closed microfluidic cartridge may be especially desirable for testing potentially infectious samples. In some embodiments, once the sample is in a microfluidic reservoir and a minimum fluid volume is verified, a driving pressure is created to move the fluid sample from the microfluidic reservoir into a plurality of fluid-flow paths (also called channels or lanes), each of which may comprise one or more chambers (also called wells) along its path. In some embodiments, a cartridge may have a plurality of channels, wherein at least some channels each comprise chambers connected in series. In certain embodiments, each channel may contain reagents for a different assay; and in other embodiments, some of the channels or all channels may contain the same reagents, for the same assay. In certain embodiments, channels may comprise the same reagent but at different concentrations (e.g., three channels may contain Factor Xa, but the concentration of Factor Xa may vary across the channels). Each of the channels may lead to a sensing chamber or well, and excess sample may be received in one or more waste bins such as 90.

FIG. 2A shows an exemplary base structure of a cartridge assembly 60, the fluidic flow for which is schematically represented in FIG. 2B. In a preferred embodiment, the pressure source is generated by a device (not shown) that pushes a pressurizing chamber, for example, plunger (e.g., a piston, bung, etc.) 80 in cartridge 60's hollow cylindrical structure 81 (also called cylinder 81), which is connected by channel 82 to the region containing a plurality of microfluidic channels. The pressurizing chamber (e.g., cylinder 81) may contain gas, fluid, or both. Some embodiments may use an alternative component for applying pressure, such as a bellows instead of a piston/cylinder arrangement. Actuation of the pressure source (e.g., motion of the piston into the cylinder) is controlled to provide the desired pressure and flow rate within the microfluidic system.

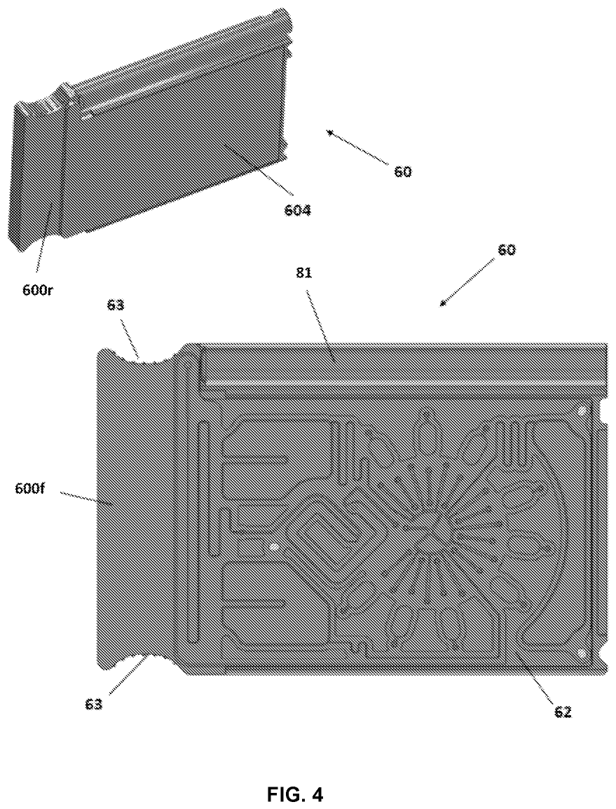

The cartridge assembly 60 may comprise an array of components. In some embodiments, as shown in the embodiment in FIG. 3, the cartridge body 600 includes a plunger 80 in cylinder 81, filter plug 608, support ring 605, and sample insertion port 600i. In some embodiments, a cartridge assembly may have fewer or additional components; for example, the support ring 605 for layer 606 may be replaced with integrally molded spokes or mesas. As further shown in FIG. 4, the cartridge assembly 60 may include at least three main regions: a pressurizing chamber 81, a main fluidic body 62, and a handle region 63.

In certain embodiments, a first pressure sensitive adhesive (PSA) layer 606, a second PSA layer 607, and a circuit board 800 are each kinematically aligned to the cartridge body 600 and adhered or bonded (e.g., with adhesive, laser or ultrasonically welded, heat sealed, etc.) to at least one of the other component layers (see, for example, FIG. 3 & FIG. 4). Each of the first PSA layer 606 and the second PSA layer 607 may have single-sided or double-sided adhesive. A back seal layer 604 (which is also referred to herein as backing plate 604) also may be bonded to the bottom of the cartridge body 600 to enclose one or more flow paths in the cartridge body 600 to form channels. The sample insertion port 600i may be closed with a removable cap 603 that can be made of an elastomeric material so that it can be pressed in place and remain attached. Alternatively, the cap 603 can be attached by a threaded or Luer lock connection.

The cartridge body 600 can be made by precision injection molding of medical grade plastic for microfluidics (e.g., polycarbonate plastic). In some embodiments, particularly where very fine features are desired, the cartridge body may be injection molded using a Liquid Crystal Polymer known for its ability to form very fine features. Some of the smallest features that can be made by injection molding are on the order of about 40 micrometers wide, with a tolerance of plus or minus about 5 micrometers. The depth, for example, on a 40-micrometer wide channel is typically on the order of about 10 to about 20 micrometers. As the width increases to about 100 micrometers or more, features may become easier to manufacture and the cost of molds thus may be reduced. For molded features on the order of about 200 micrometers in size, tolerances may be on the order of about 5 percent. Vias (openings in elements that create vertical channels and allow for the transfer of fluid along the Z-axis of the cartridge system) are typically made using drop pins in the injection mold; because of these openings, seal layers may be required (in an illustrative embodiment, e.g., 604 may be bonded to seal the backside of 600, and circuit board layer 800 may be used to seal the cartridge on its frontside). Current manufacturing techniques allow for approximately 0.5 mm diameter drop pins with about a 3 degree taper.

Layers of PSA 606 and 607 (which may be in the form of a film) can be added to the cartridge to create fluid connections and additional vias and flow features (e.g., reservoirs for fluid logic). Layers of PSA can be mass produced by commercial laser cutting or by stamping (e.g., die cutting). Small production runs also can be achieved with off-the-shelf laser cutters, depending on the desired resolution. For example, a 40 W CO₂ laser engraver (e.g., the OMTech laser K40 model) may have a resolution of about 1500 DPI, which translates to a minimum feature size of about 16.9 μm. Some units (e.g., the OMTech 50 W upgraded unit) are available at about 4500 DPI, which translates to a pitch of about 5.6 μm. Depending on the pattern and volume desired for the features, the PSA material may be die cut into a PSA layer having the desired geometry.

Each PSA layer may have an adhesive on its surface. In some embodiments, the adhesive may be exposed by peeling off a cover sheet, such as, for example, 3M 1513 double-sided adhesive tape. There are significant challenges in ensuring that thin adhesive layers (e.g., adhesive films) are placed with both precision and accuracy. For example, PSA layers typically are thin and compliant and thus easily deformed. Further, if the alignment of a PSA layer is off, features (e.g., vias) may not align. One advantage of using a PSA layer, which itself may have one or more integrated adhesive layers that may be made of particular chemical compositions, is that, depending on the adhesive, adhesion of the PSA layer to other cartridge elements may be achieved with little or no heat, making it less likely that the PSA layer will sag and/or flow into the microfluidic channels. In some embodiments, for example where test reagents are pre-deposited within the microfluidic channels (e.g., in chambers of the channels) to be sealed with a PSA layer, using a PSA layer with an adhesive that does not require high heat may ensure that reagents, such as proteins, do not denature (e.g., as a result of applying higher temperatures).

FIG. 3 depicts a PSA layer 606 that has an adhesive layer facing the cartridge body 600's front face 600f. In the exemplary embodiment depicted in FIG. 4, back layer 604 is thicker than PSA layer 606 and may be bonded or adhered to the rear face 600r of cartridge body 600, using any of several possible methods (e.g., with an adhesive, by pressure, heat, ultrasonic welding, etc.). In certain embodiments, if back layer 604 is clear and the back face 600r has bond regions that have been scuffed up (e.g., to be made opaque), laser welding through the clear back layer becomes easier in those regions. Similarly, if one of the layers to be adhered or bonded is opaque in color, for example if cartridge body 600 is black and back layer 604 is clear, laser welding may also be used.

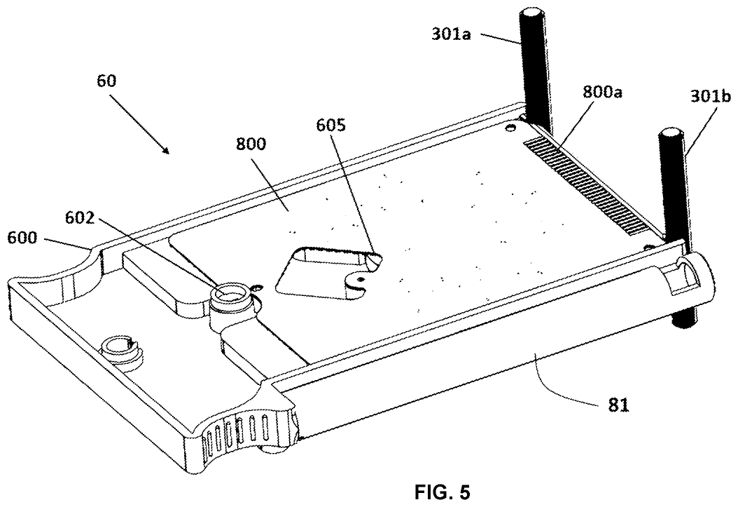

The PCB layer 800 can be rigid or flexible, or may itself comprise layers with one or more of such layers being flexible and other layer(s) being rigid. In an exemplary embodiment, a flexible PCB made of Kapton® is attached to (e.g., adhered to, laser welded to, etc.) a rigidized layer (such as a rigid PCB). Additionally, PCB layer 800 may comprise at least one set of contact pads 800a (see FIG. 5) that can be used for making electrical contact with the cartridge's other elements, to establish communication with the cartridge's elements for analyzing the fluidic regions of cartridge 60. For example, impedance sensing circuits on the circuit board facing the microfluidic features may measure impedance of a blood sample mixed with reagents when voltage is applied (e.g., to detect clotting, disease, etc.). In some embodiments, a rigid PCB may be made of a common material (e.g., FR-4, other epoxy-glass laminates, etc.), use of which may be desirable for its low cost, ease of manufacturing, and/or material properties (e.g., high temperature tolerance). In other embodiments, use of a flexible PCB, such as a PCB made with Kapton®, may be preferable based on the tests intended for the cartridge (e.g., fluorescence-based assays with which PCBs made of epoxy-glass laminates may interfere). In certain embodiments, a rigid PCB made of, for example, paper-phenolic (e.g., FR-3 paper-epoxy), polyethylene (PET), Poly Ether Sulphone (PES), etc., may also allow for specific tests to be performed (e.g., specific florescence-based tests).

In various embodiments, it may be desirable to maintain the fluid inside the fluidic testing region at a specific temperature. Thus, in certain embodiments the PCB layer 800 may comprise heating or other temperature-control elements (e.g., within the layers of the electronics) that are able to achieve and maintain a particular temperature or temperature range, such as, e.g., temperatures as low as about 20° C., and/or temperatures as high as about 45° C. For example, for a cartridge used to evaluate coagulation in a sample, the temperature can be about 37° C. Single or multiple temperature sensors and/or controller circuits can be included in the PCB layer 800, to monitor temperature and achieve and/or maintain a desirable temperature over all of the fluidic regions or over particular fluidic regions (such as those regions where reactions occur and/or measurements are taken). Temperature measurements also may be used by a testing unit for a specific feedback temperature control system.

In addition, in certain aspects, as the temperature increases above approximately 65° C., and with minimal structural support, it may become likely for one or more PSA layers to delaminate. Thus, it may be desirable to adjust to and/or maintain a particular temperature operational range (e.g., a temperature that does not exceed 65° C.), by any one or any combination of techniques and/or materials (such as those described above). In addition, techniques may be employed, and certain materials may be used, that help protect against delamination of the PSA (e.g., a PSA layer with particular adhesive properties may be used) or that eliminate this concern (e.g., laser welding or ultrasonic welding may be used in place of PSA, etc.).

In various embodiments, non-fluid flow regions of a cartridge may not all be filled (e.g., with plastic), particularly if the cartridge comprises one or more precise molded parts that have many microfluidic channels comprising well regions; otherwise, the cartridge can suffer from hot spots that may warp and/or may result in a loss of desired accuracy. Such is the case for annular region 605a, which in some embodiments must be left hollow. In such embodiments, however, the PSA layers 606 and 607 may depress into region 605a, and fluid pressure in the vias connecting the layers, and/or fluid pressure over the hollow annular region 605a, may cause one or more of the layers to separate, even though they had been adhered or bonded together. Support ring 605 thus may be inserted into the annular region to act as a back-up structure. In another embodiment, radial spokes in the base structure creating the hollow annular region can be included, such that the spokes are located underneath the PSA layers and in between where the radial microfluidic structures are located. In still other embodiments, support may be provided to the hollow annular region by filling the region with additional material through an overmold process, which may allow for a flat surface finish to be achieved.

In some embodiments, the cartridge comprises one or more waste bins. In certain embodiments, the waste bins are fixed-volume waste bins. For example, in some embodiments, the volume of waste bins, such as 90, may be larger than the volume of fluid introduced into the cartridge, thereby constituting a closed system in which no fluid exits the cartridge. Having such a closed system may be particularly desirable, for instance, for use with potentially contagious samples and/or harmful agents. In such embodiments, pressure in the waste bins may rise in proportion to the ratio of the fluid volume that is introduced to the volume of the waste bins. Additionally, as fluid is introduced, pressure may rise, placing increasing demand on, for example, the actuator (e.g., to drive the fluid) and the bond or adhesion strength needed between layers (e.g., to keep the fluid contained within desired channels).

In additional embodiments of the present invention, the waste bins may dynamically vary in size and may thus receive waste at a constant pressure. For example, a cylindrical volume 81w (not shown) may be located on the side of the cartridge 60 opposite from the input cylinder 81, making the cartridge appear symmetric externally. In certain such embodiments, a cylinder 81w may be sealed with an outwardly movable piston plug, thereby providing a dynamic waste volume receptacle. For example, the piston can be actuated near the open end of the cylinder, as waste enters the cylinder and fills the cylinder's volume, at which point the piston plug is pushed by a moving rod. In addition, the waste cylinder's piston can be located near the inner end, such that, as the input volume's piston moves into its cylinder, the waste volume's piston moves out towards its open end. In another embodiment, the waste volume is a bellows that expands to receive the waste volume.

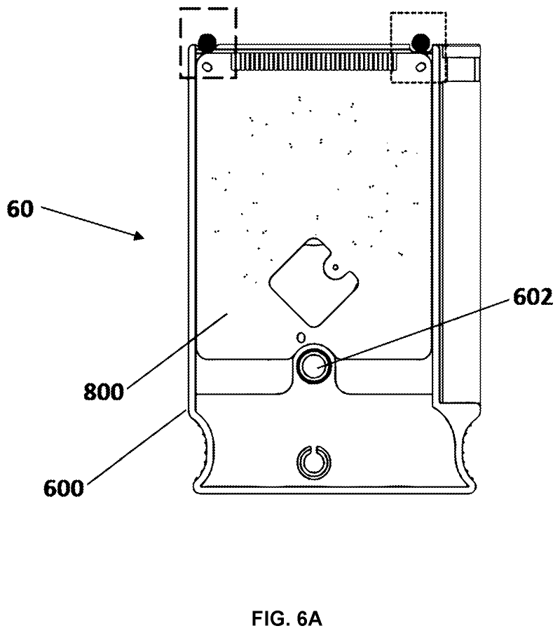

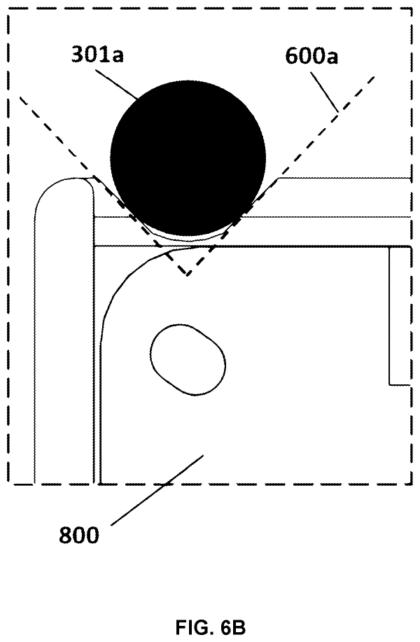

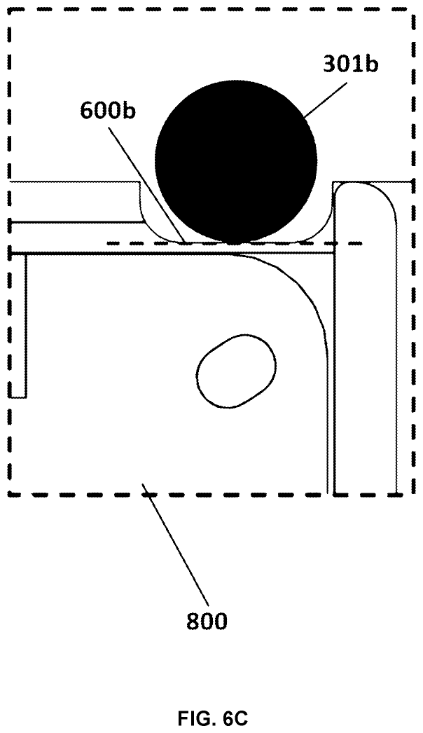

When the cartridge (e.g., cartridge assembly 60) is inserted into a machine to actuate the cartridge and gather data on the fluid to be evaluated in the cartridge, it is critical to accurately align the cartridge to the machine. The anterior end of the cartridge assembly 60 thus may have a kinematic (exact constraint) region consisting of a V-shaped region 600a and a flat region 600b, which make 3-point contact with reference geometry, for example, to two dowel pins 301a and 301b that would be located in an instrument designed to receive the cartridge, as shown in FIGS. 5 and 6A-6C. Dowel pins are manufactured in great quantities for very low cost and are used for aligning parts and “pinning” them together to prevent shear between parts. Preloading the cartridge assembly 60 toward the two dowel pins 301a and 301b precisely locates the cartridge with respect to the receiving instrument, which in turn may have probing electrical contacts to mate with corresponding contact pads 800a (of PCB layer 800) on the cartridge, thereby precisely aligning the contact pads 800a to the receiving instrument into which the cartridge is placed. With the two dowel pins engaging the V and flat regions, precision may be on the order of about 10 to about 100 microns, which is sufficient to align the contact pads 800a to the electrical contacts on the receiving instrument. In various embodiments, electrical contact pins on PCB layer 800 may have about 1 mm pitch for a PCB having a contact pad that has a width of about 600 μm. In certain embodiments, the PCB may have 16 to 48 electrical contact pins.

With respect to assembly of multi-layer microfluidic cartridges as described herein, alignment slots and pins are used to achieve accurate and precise alignment between the layers. In certain embodiments, the layers may have microfluidic features on the order of about 0.2 mm, and thus alignment between the layers (e.g., between the base structure and the next additional layer, and between each subsequent layer) should be sufficiently accurate to allow the cartridge to function as intended (e.g., alignment between the layers may need to be accurate to within about 40 microns). Such accurate alignment cannot be easily achieved by conventional edge contact alignment to an assembly fixture because of inadequate edge accuracy and because of inadequate accuracy of the positions of internal features with respect to an edge. For example, the outside edges on a molded part are far from internal precision features and are often thicker than the internal precision features, resulting in shrinkage-induced dimensional error. In addition, conventional alignment techniques that use pins in holes or pins in a hole and slot often over constrain or under constrain parts, resulting in assembly quality problems. In contrast, as described herein, slots are used as kinematic coupling points.

As described in embodiments herein, an exact constraint method is used to ensure accurate and precise alignment between the layers (e.g., the base structure, the PSA layers, the PCB layer, etc.). The method involves three kinematic alignment slots, such that the relative position of the kinematic alignment slots with respect to small microfluidic features is in exact precision alignment. Only the clearance space around a pin that fits in a slot could cause misalignment error, and because the slots' width can be made with great precision, and pins further may be ground with great precision, precise alignment between layers can be achieved to a level on the order of five to ten microns.

Three pins engaging with three slots (e.g., pins 961d in slots 600z) can thus uniquely define the position of a layer whose slots are engaged with the pins, even if the pins' centers themselves are not accurately aligned with the slot's centroids. In some embodiments, the pins are located on the cartridge's base structure; in other embodiments, the pins emanate from an assembly fixture.

For example, in some embodiments, the pins emanate from an assembly fixture such that the pins' centers are located at the ideal centers (centroids) of the slots in the layers; however, even if the location of the pins' centers are off by as much as about 0.5 mm within the slots, each layer's slots will find a unique location for the layer on the pins. And while each layer's slots are precisely located with respect to the layer's microfluidic features, having one or more layers stacked on one or more layers with the pins passing through each layer's slots will still ensure that the layers (and the layers' features) are precisely and accurately aligned with respect to each other. Using three slots and alignment pins as described herein, many layers may be stacked with great location precision and accuracy between and among the layers. Precision of placement is limited only by the precision of the molding process for the slots. Precise stacking of the layers is important for precise alignment of the layers' features, and can also be important to ensuring sufficient bonding or adhesion of the layers to each other.

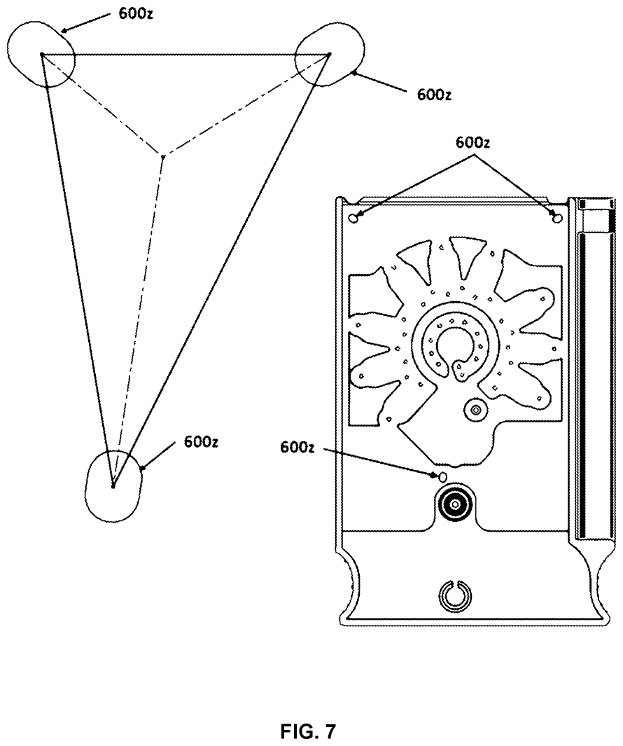

In exemplary embodiments, the layers that are stacked on the cartridge body 600 are aligned using three slots 600a, 600b, and 600c arranged in a triangle shape, as shown in FIG. 7. In various embodiments, each of the one or more layer elements (e.g., the cartridge body 600 that comprises the base structure, and each of the one or more other layers) has three slots of identical size, and the three slots further are identically located and oriented in each layer with respect to critical features to be aligned between and among the layers. The three slots may engage with three pins on an assembly fixture, whereby the three slots' centers are located on a virtual triangle where the angle bisectors of the triangle's included angles meet at a point that is in the region of greatest alignment accuracy desired between the elements (elements including, e.g., the wells where the sensing or testing of the sample occurs), and the slots' centers are located on the triangle vertices and their longitudinal axis are aligned with the corresponding angle bisectors at the triangle vertices. This point is effectively the instant center of rotation of the layer, and if located near the sensing region, amplification of rotational errors into location errors will be minimized. Each layer has identical slots located in identical positions and orientations with respect to the cartridge's overall structure, such that all microfluidic features on each layer are accurately and precisely aligned when the slots are all aligned. During assembly, a pin may be entered into each slot, and each pin may contact one long side of the slot or the other long side of the slot. With such contact, there are three contact points between the three pins and the three slots in each layer, with each pin contacting a side of the slot to which it is inserted. There being three unique contact points, three degrees of freedom are thus defined between a layer and the three pins (X, Y (planar), and rotation about a normal to the surface plane of a layer), and hence between each layer. In certain embodiments, it is important that the width of the slots be minimally wider than the diameter of the pins, where the width is dictated by the manufacturing tolerance achievable by the selected manufacturing process. The amount by which the slots are wider than the diameter of the pins is the limit of the alignment precision between layers. However, since this tolerance is a local tolerance (e.g., tolerance of slot width) rather than a global tolerance (e.g., the location of the slot in the layer), sufficient slot width precision can be achieved. In some embodiments, slot width may be about 20 microns wider than the pin diameter. In embodiments employing LCP molding, slot width may be as small as ten microns, and pins may be inserted into slots within about a 5 micron accuracy.

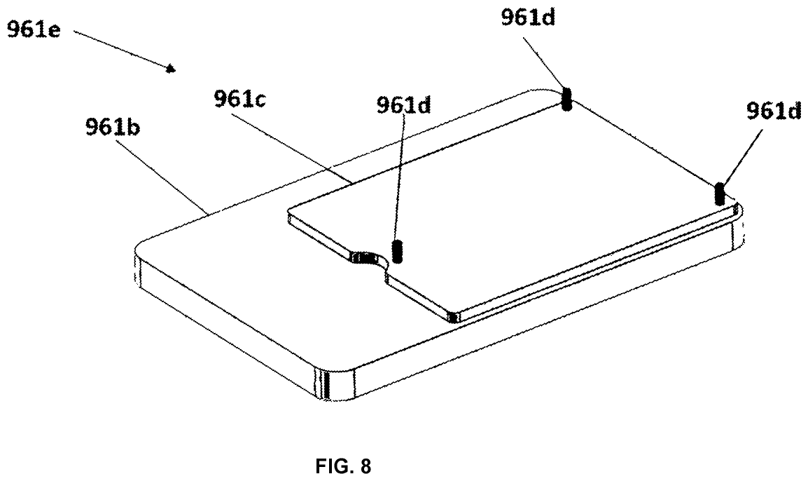

This method of assembly may take various forms. For example, as shown in FIG. 8, in some embodiments, the slots on the one or more layers of a cartridge (e.g., PSA layers 606 and 607) can be used to align each of the one or more layers to fixture 961e with three alignment pins 961d nominally located on what would be the centers of the slots on the layers. The alignment pins may be precision-ground dowel pins. Fixture 961e may comprise a base 961b and a compliant material 961c, which may aid in pressing layers together. The compliant material 961c may have a durometer hardness in the range of about 20A to about 70A; in some embodiments, it may be preferred that the base 961b and/or compliant material 961c be porous (e.g., the base may comprise a graphite or ceramic material, and the compliant material may comprise an open cell foam). A layer is placed with its slots going over the three pins. At this point, if a vacuum is used, it can be turned on to hold the layer flat. If the layer has a cover sheet over adhesive, the cover sheet may then be removed without distorting the layer, and the layer with its exposed adhesive then may be aligned with other layers whose slots are placed over the pins, and the layers may then be pressed together without risk of an adhesive bubble forming, which often otherwise happens when thin adhesive backed layers are pressed onto surfaces. In some aspects, the compliant layer 961c may also have height (Z-axis) features; for example, such features may help modulate the pressure applied to the layers in particular regions of interest. Depending on the design of the layer, in some embodiments, certain regions may require the application of more pressure than other regions to improve bonding or adhesion.

In some embodiments, the next layer element to be adhered to or bonded with the layer held on the assembly fixture 961e is placed on a similar fixture (not shown, but referred to herein as fixture 961r) surface, which also may comprise a porous material that allows the layer to be held in place by a vacuum once it has been placed over the pins. The surface of such vacuum fixture 961r may comprise three slots with retractable guide pins, with the slots and the pins being located on the surface so as to match the location of the three slots on the layer. Once the layer is placed on the vacuum fixture surface and its position secured via the retractable pins, the vacuum may be turned on to hold the layer in place and the pins may then be retracted. The fixture 961r is then brought onto fixture 961e, where the pins in 961e engage the slots in the layer (and fixture 961r) to align the assembly fixture (and the layer(s) it holds) to the layer on fixture 961r. Fixture 961r then moves downward until the layers are within about 0.5 mm of contact, and the vacuum that holds the layer to 961r is turned to pressure to blow the 961r-held layer onto the layer on the assembly fixture 961e. Continued downward motion of 961r then creates bonding pressure between the two layers by compressing the compliant layer 961c.

Alternatively, in some embodiments, fixture 961e may function as a master vacuum chuck with three alignment pins having tapered ends whose length protruding from the chuck 961e is less than about half the depth of the kinematic alignment slots in the cartridge body 600. A second vacuum chuck 961e′ (not shown) also has three pins whose length protruding from the chuck 961e′ is less than about half the depth of the kinematic alignment slots in the cartridge body 600. The cartridge body 600 is then placed onto the chuck 961e′ and held by vacuum. A layer to be adhered or bonded to cartridge body 600 is placed on master chuck 961e. For example, a PSA layer (e.g., PSA layer 606) is placed on the chuck 961e, with the alignment slots of the PSA layer engaging the alignment pins on the chuck, and the vacuum is turned on to hold the PSA layer flat. If the adhesive on the PSA layer is covered, then such cover on the adhesive is removed. The chuck 961e′ (which holds cartridge body 600) is compliantly held, such as with a Remote Center Compliance (RCP) device often used in robotic assembly systems, and brought down onto the master chuck 961e such that the three tapered-end pins in chuck 961e engage the three slots in the cartridge body 600, and where any misalignment between the chucks due to robot inaccuracy will be accommodated by the RCP unit being displaced by the master chuck 961e pins engaging the cartridge body's slots. Once initial engagement is made, the vacuum of chuck 961e′ can be reversed to blow, and the cartridge body 600 will fall precisely onto the PSA layer held by the master chuck 961e. The robot arm removes chuck 961e′ and applies pressure with a compliant flat surface to adhere the cartridge body to the PSA layer. This assembly is then transferred back to the chuck 961e′ and a new layer is placed onto master chuck 961e and the process can be repeated.

In the above assembly modes, the backing plate 604, which may be relatively thick (e.g., about 1 mm), can be placed (e.g., manually, robotically, etc.) in an acceptable position on cartridge body 600. If desired, the backing plate 604 can also have slots and the assembly fixture 961e may be used to align and bond 600 and 604.

In some embodiments, the cartridge body 600 with its backing plate in place can float like an air hockey puck on a porous chuck 961e″ (not shown, and which may apply air pressure or vacuum). In such embodiments of the assembly process, PSA layer 606 is placed with its slots sliding over the pins of a master assembly fixture (e.g., 961e); such pins may be tapered. In embodiments where such master assembly fixture comprises a vacuum, the vacuum is turned on and any cover on layer 606's adhesive is removed. Further, the baseplate (which is the cartridge body 600 with its backing plate 604) with its slots is placed on chuck 961e″ (which may employ a vacuum) so it is free to float within a region that has radial clearance that is less than half the width of the cartridge body's alignment slots. No pins are needed in chuck 961e″. Soft radial springs, such as foam, also may be used to nominally locate the cartridge baseplate. Chuck 961e″ is parallel to assembly fixture 961e (which in this embodiment is a vacuum chuck controllably connected to air pressure or vacuum) held on a vertical motion slide or an assembly robot with layer 606 now facing downward. As 961e is lowered, the pins on 961e, which may have tapered ends, engage the cartridge body 600's slots, and since the baseplate is nominally located by the radial constraints, it will readily move to position with the pins on 961e piercing the cartridge body's slots. Motion continues downward until the PSA layer 606 contacts the front face 600f of the cartridge body 600, and continued force creates pressure so the PSA layer adheres to the cartridge body. The vacuum turns to pressure and the assembly fixture 961e is raised, leaving the PSA layer 606 adhered to face 600f of the cartridge body. The process may be repeated to add additional layers.

For example, PSA layer 607 similarly may be placed on fixture 961e and vacuumed down. Any adhesive layer cover sheet is removed, and the process above is repeated, wherein, now, layer 607 is adhered to layer 606. Finally, the PCB layer 800 is placed onto 961e and a vacuum is turned on to hold it. Any adhesive cover on the second side of 607 is removed and, again, since the assembly 604, 600, 606, and 607 is floating on the air-bearing chuck, when the PCB layer held to the assembly fixture 961e is lowered down, the assembly fixture 961e's pins will engage the slots in the cartridge body with its bonded or adhered layers, whose slots by the above process are all precisely aligned without resistance due to the air bearing float feature. Continued downward motion then pushes the PCB layer 800 precisely against the adhesive on layer 607, and resulting pressure adheres the PCB layer to the assembly. In certain embodiments, this process may thus complete a cartridge; in other embodiments, the assembly process may be repeated to bond or adhere additional layers to the assembly.

In general, parallelism between the chuck surfaces should be greater than about 0.1 mm and thus, use of a simple arbor press is not preferred in assembly. The vertical motion is best achieved with a precision press that uses rolling element linear guide bearings to keep the platens parallel with a closed structural loop, such that, when force is applied, there is no angular bending motion of the press's frame to cause uneven pressure. Alternatively, if a robotic system is used where alignment cannot be guaranteed to this level, a RCP device can be used to allow for angular float between the chucks.

It will be appreciated that the methods and systems described above are set forth by way of example, and that the examples do not limit the scope of the invention. In addition, the order or presentation of method steps in the description above is not intended to require this order of performing the recited steps, unless a particular order is expressly required or is otherwise clear from the context. Thus, while this invention has been particularly shown and described with references to certain embodiments thereof, it will be understood in light of the present disclosure by those skilled in the art that various changes in form and details may be made therein without departing from the scope of the invention, for example as encompassed by the appended claims.

What is claimed is:

1. A cartridge comprising a base structure and a layer, wherein the layer is bonded or adhered to the base structure, and wherein:
each of the base structure and the layer comprises three slots, wherein the three slots in the base structure are the same size as, and have the same planar (X, Y) and angular orientations as, the three slots in the layer, such that alignment of the three slots in the base structure with the three slots in the layer results in planar and rotational alignment of the base structure with the layer.

2. The cartridge according to claim 1, further comprising one or more additional layers, wherein each of the one or more additional layers comprises three slots having the same size as, and having the same planar (X, Y) and angular orientations as, the three slots in the base structure and the three slots in the layer, such that alignment of the three slots in each of the one or more additional layers with the three slots in the base structure results in planar and rotational alignment of the base structure, the layer, and the one or more additional layers.

3. The cartridge according to any one of claims 1-2,
wherein the three slots in the base structure are positioned in the base structure such that their centers lie on a first virtual triangle, with each slot's center located on one of the first virtual triangle's vertices, and with each slot's longitudinal axis aligned with the one of the angle bisectors of the first virtual triangle's included angles, and
wherein the three slots in the layer are positioned in the layer such that their centers lie on a second virtual triangle, with each slot's center located on one of the second virtual triangle's vertices, and with each slot's longitudinal axis aligned with the one of the angle bisectors of the second virtual triangle's included angles, and
wherein the angle bisectors of the first virtual triangle's included angles meet at a first point that is within the first virtual triangle, and the angle bisectors of the second triangle's included angles meet at a second point that is within the second virtual triangle.

4. The cartridge according to claim 3, wherein the position of the first point that is within the first virtual triangle is aligned with the position of the second point that is within the second virtual triangle.

5. A cartridge comprising a base structure and one or more layers,
wherein the base structure comprises three slots and the one or more layers each comprises three slots, wherein all slots have the same size and the same planar (X, Y) and angular orientations, and
wherein the three slots in the base structure are positioned in the base structure, and the three slots in each of the one or more layers are positioned in each layer, such that alignment of the three slots of the base structure with the three slots in each of the one or more layers results in planar and rotational alignment of features of the base structure with features of the one or more layers.

6. A microfluidics cartridge comprising a base structure, a first layer, and one or more additional layers, wherein the first layer is adhered to or bonded with the base structure, and:
wherein the base structure comprises three slots, the first layer comprises three slots, and each of the one or more additional layers comprises three slots, wherein all slots have the same size, and
wherein the first layer's three slots are positioned in the first layer such that they have the same planar (X, Y) and angular orientations as the base structure's three slots and such that their alignment with the base structure's three slots provides planar and rotational alignment of the first layer with the base structure, and
wherein the three slots of each of the one or more additional layers are positioned in each of the one or more additional layers such that they have the same planar (X, Y) and angular orientations as the base structure's three slots and such that their alignment with the base structure's three slots provides planar and rotational alignment of each of the one or more additional layers with the base structure.

7. The microfluidics cartridge according to claim 6,
wherein the three slots in the base structure are positioned in the base structure such that their centers lie on a first virtual triangle, with each slot's center located on one of the first virtual triangle's vertices, and with each slot's longitudinal axis aligned with the one of the angle bisectors of the first virtual triangle's included angles, and
wherein the three slots in the first layer are positioned in the first layer such that their centers lie on a second virtual triangle, with each slot's center located on one of the second virtual triangle's vertices, and with each slot's longitudinal axis aligned with the one of the angle bisectors of the second virtual triangle's included angles, and
wherein the angle bisectors of the first virtual triangle's included angles meet at a first point that is within the first virtual triangle, and the angle bisectors of the second triangle's included angles meet at a second point that is within the second virtual triangle.

8. The microfluidics cartridge according to claim 7, wherein the position of the first point that is within the first virtual triangle is aligned with the position of the second point that is within the second virtual triangle.

9. The cartridge according to any one of claims 1-4, wherein the layer is an adhesive layer.

10. The microfluidics cartridge according to any one of claims 6-8, wherein the first layer is an adhesive layer.

11. A method for assembling the cartridge of claim 9, the method comprising:
placing the adhesive layer on a vacuum chuck comprising three pins that protrude outward from the vacuum chuck, wherein the adhesive layer's three slots slide over the pins of the vacuum chuck;
placing the vacuum chuck on a vertical motion slide, such that the adhesive layer placed on the vacuum chuck is facing downward;
placing the base structure on an air-bearing chuck such that the base structure floats, wherein the air-bearing chuck and vacuum check are positioned to be parallel to each other and to face each other;
lowering the vacuum chuck, such that the vacuum chuck's three pins enter into the base structure's three slots, and continuing to lower the vacuum chuck until the adhesive layer contacts the base structure; and
applying pressure to the adhesive layer through the vacuum chuck.

12. The method according to claim 11, wherein the length of each of the three pins on the vacuum chuck is less than the depth of the three slots in the base structure.

13. The method according to any one of claims 11-12, wherein the three pins on the vacuum chuck are tapered.

14. The method according to any one of claims 11-13, wherein the air-bearing chuck comprises edge alignment features that allow alignment of the base structure to the edge alignment features.

15. The method according to any one of claims 11-14, wherein the adhesive layer comprises a cover, and wherein the method further comprises removing the cover from the adhesive layer after placing the adhesive layer on the vacuum chuck and prior to lowering the vacuum chuck.

16. A method for assembling a microfluidics cartridge comprising a base structure and an adhesive layer that is adhered to the base structure, the method comprising:
placing an adhesive layer comprising three slots on a vacuum chuck comprising three pins that protrude outward from the vacuum chuck, wherein the adhesive layer's three slots slide over the pins of the vacuum chuck;
placing the vacuum chuck on a vertical motion slide, such that the adhesive layer is facing downward;
placing a base structure comprising three slots on an air-bearing chuck such that the base structure floats, wherein the air-bearing chuck and vacuum check are positioned to be parallel to each other and to face each other;
lowering the vacuum chuck, such that the vacuum chuck's three pins are inserted into base structure's three slots, and continuing to lower the vacuum chuck until the adhesive layer contacts the base structure; and
applying pressure to the adhesive layer through the vacuum chuck.

17. The method according to claim 16,
wherein the three slots in the base structure and the three slots in the adhesive layer have the same size, and
wherein the three slots in the base structure are positioned in the base structure, and the three slots in the adhesive layer are positioned in the adhesive layer, such that the three slots in the base structure have the same planar (X, Y) and rotational orientations as the three slots in the adhesive layer, and such that alignment of the three slots in the base structure with the three slots in the adhesive layer results in planar and rotational alignment of features of the base structure with features of the adhesive layer.

18. The method according to any one of claims 16-17,
wherein the three slots in the base structure are positioned in the base structure such that their centers lie on a first virtual triangle, with each slot's center located on one of the first virtual triangle's vertices, and with each slot's longitudinal axis aligned with the one of the angle bisectors of the first virtual triangle's included angles, and
wherein the three slots in the adhesive layer are positioned in the adhesive layer such that their centers lie on a second virtual triangle, with each slot's center located on one of the second virtual triangle's vertices, and with each slot's longitudinal axis aligned with the one of the angle bisectors of the second virtual triangle's included angles, and
wherein the angle bisectors of the first virtual triangle's included angles meet at a first point that is within the first virtual triangle, and the angle bisectors of the second triangle's included angles meet at a second point that is within the second virtual triangle.

19. The method according to claim 18, wherein the position of the first point that is within the first virtual triangle is aligned with the position of the second point that is within the second virtual triangle.
